(19) United States
(12) Patent Application Publication
(10) Pub. No.: US 2017/0190336 A1
(43) Pub. Date: Jul. 6, 2017

(54) Automated Vehicle Operation Based On Gesture To Pedestrian

(71) Applicant: Delphi Technologies, Inc., Troy, MI (US)

(72) Inventors: Indu Vijayan, Sunnyvale, CA (US); Michael H. Laur, Mission Viejo, CA (US); John P. Absmeier, Capitola, CA (US)

(21) Appl. No.: 14/987,188

(22) Filed: Jan. 4, 2016

(51) Int. Cl. B60W 50/10; G08G 1/005; B60Q 1/52; G05D 1/00; B60Q 5/00

(52) U.S. Cl. CPC B60W 50/10; G05D 1/0088; B60Q 5/006; B60Q 1/525; G08G 1/005

(57) ABSTRACT

A gesture detection system suitable to operate an automated vehicle includes a gesture-detection-device, a pedestrian-detection-device, and a controller. The gesture-detection-device is used to detect a gesture made by an occupant of a host-vehicle. The pedestrian-detection-device is used to detect a pedestrian proximate to the host-vehicle. The controller is in communication with the gesture-detection-device and the pedestrian-detection-device. The controller is configured to control movement of the host-vehicle along a travel-path of the host-vehicle. The controller waits to move the host-vehicle until after the pedestrian crosses the travel-path when the occupant gestures to the pedestrian to proceed across the travel-path.

### TECHNICAL FIELD OF INVENTION

This disclosure generally relates to a system for operating an automated vehicle, and more particularly relates to detecting a gesture made by an occupant of the vehicle to a pedestrian outside of the vehicle, and operating the vehicle in accordance with the gesture.

### BACKGROUND OF INVENTION

The advent of automated vehicles makes it possible for an operator of an automated vehicle to, for example, read a news article on a tablet, or conduct business via a phone and/or computer while traveling in an automated vehicle. However, a pedestrian preparing to cross in front of an automated vehicle may hesitate if the operator or occupant of the vehicle appears to be unaware of the presence of the pedestrian, or is uncertain of how the automated vehicle will behave.

### SUMMARY OF THE INVENTION

In accordance with one embodiment, a gesture detection system suitable to operate an automated vehicle is provided. The system includes a gesture-detection-device, a pedestrian-detection-device, and a controller. The gesture-detection-device is used to detect a gesture made by an occupant of a host-vehicle. The pedestrian-detection-device is used to detect a pedestrian proximate to the host-vehicle. The controller is in communication with the gesture-detection-device and the pedestrian-detection-device. The controller is configured to control movement of the host-vehicle along a travel-path of the host-vehicle. The controller waits to move the host-vehicle until after the pedestrian crosses the travel-path when the occupant gestures to the pedestrian to proceed across the travel-path.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is an illustration of a traffic scenario encountered by a gesture detection system in accordance with one embodiment;

FIG. 2 is a diagram of the system of FIG. 1 in accordance with one embodiment; and

FIG. 3 is an illustration of another traffic scenario encountered by the system of FIG. 1 system in accordance with one embodiment.

### DETAILED DESCRIPTION

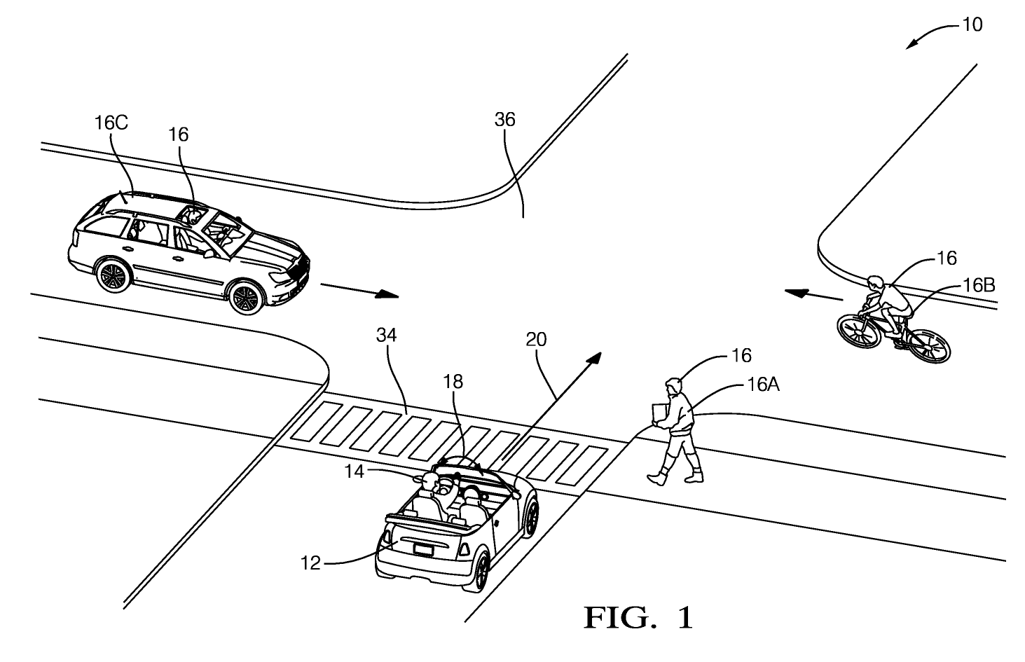

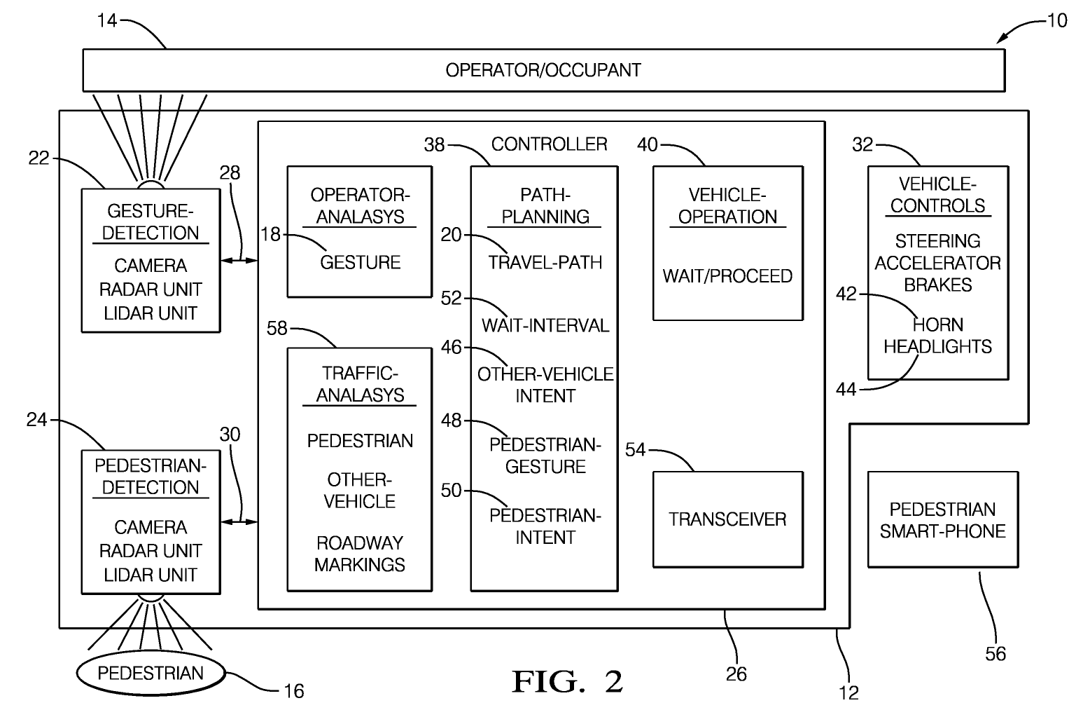

FIGS. 1 and 2 illustrate a non-limiting example of a gesture detection system 10, hereafter referred to as the system 10. The system 10 is generally suitable to operate an automated vehicle which in the description that follows is referred to as the host-vehicle 12. As will become apparent in the description that follows, the system 10 provides the means to detect when an occupant 14 of the host-vehicle 12 ‘communicates’ with a pedestrian 16 using a gesture 18 to indicate that the host-vehicle 12 will wait for the pedestrian 16 to proceed across a travel-path 20 of the host-vehicle 12.

The system 10 includes a gesture-detection-device 22 used to detect a gesture 18 made by an occupant 14 of a host-vehicle, for example an operator or passenger of the host-vehicle 12. It is contemplated that the gesture-detection-device may detect a gesture made by a passenger seated at a location in the host-vehicle 12 other than where an operator or driver of a vehicle traditionally sits. If the host-vehicle 12 is a fully autonomous type of vehicle that does not provide for any means for an occupant of the host-vehicle to control steering or braking of the vehicle, then a person traveling in the host-vehicle may be more properly referred to as a passenger or occupant rather than an operator. The gesture-detection-device 22 may include, but is not limited to, a camera such as a video camera, a radar-unit, a lidar-unit, an ultrasonic-transducer, or any combination thereof as will be recognized by those in the art.

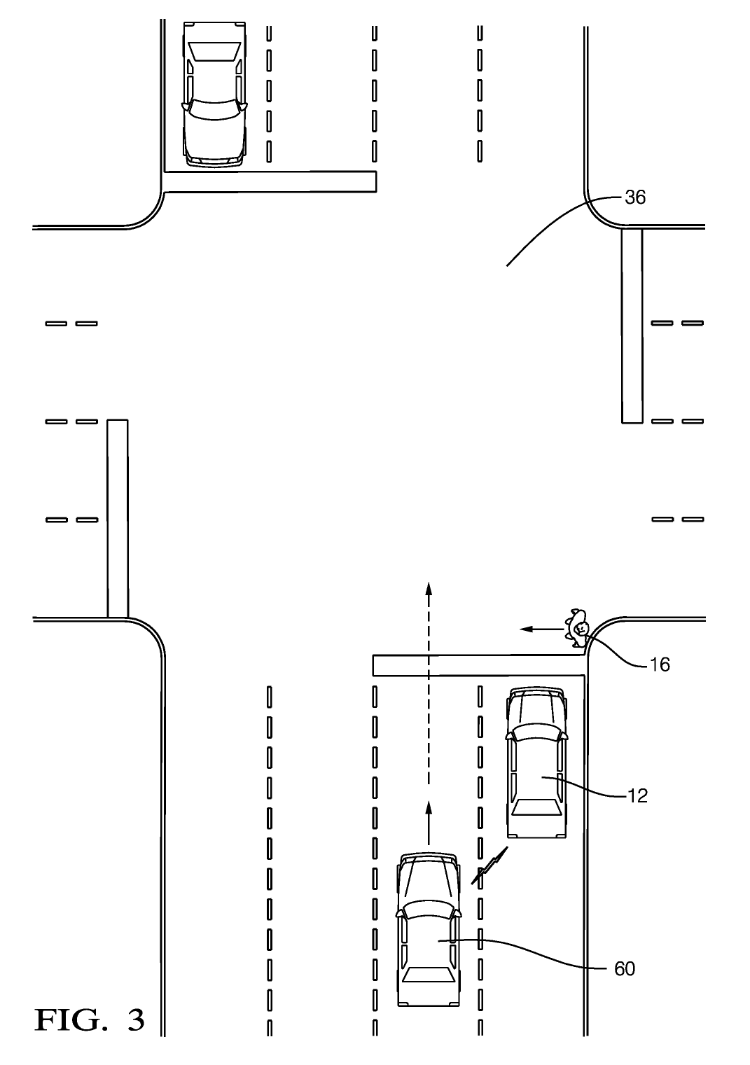

While FIG. 2 suggests that the gesture 18 is a sideways waving gesture made by the occupant 14 moving his/her arm in an appropriate manner, it is contemplated that a suitable gesture may be a hand-signal such as pointing of the finger of the occupant 14, or a head-signal such as tipping, nodding, and/or side-to-side movement of the head of the occupant 14. In one instance the gesture 18 may indicate to the pedestrian 16 that the host-vehicle 12 will wait for the pedestrian to cross the travel-path. In another instance, the gesture 18 may be an open-palm intended to advise the pedestrian to hold his/her current position because, for example, there is some perceived or unrecognized danger to the pedestrian from an approaching-vehicle 60 (FIG. 3).

The system 10 also includes a pedestrian-detection-device 24 used to detect an instance of the pedestrian 16 that is proximate to the host-vehicle 12. By way of example and not limitation, the pedestrian 16 may be a person characterized as traveling on-foot 16A, a person on a bicycle 16B, a person in an other-vehicle 16C, or any combination thereof. The pedestrian-detection-device 24 may include, but is not limited to, a camera such as a video camera, a radar-unit, a lidar-unit, an ultrasonic-transducer, or any combination thereof as will be recognized by those in the art. It is contemplated that multiple instances of the pedestrian-detection-device 24 may be preferable to enable detection of the pedestrian 16 over a wide variety of locations relative to the host-vehicle 12.

The system 10 also includes a controller 26 in communication with the gesture-detection-device 22 and the pedestrian-detection-device 24. The controller 26 may include a processor (not specifically shown) such as a microprocessor or other control circuitry such as analog and/or digital control circuitry including an application specific integrated circuit (ASIC) for processing data as should be evident to those in the art. The controller 26 may include memory (not specifically shown), including non-volatile memory, such as electrically erasable programmable read-only memory (EEPROM) for storing one or more routines, thresholds, and captured data. The one or more routines may be executed by the processor to perform steps for determining if signals 28, 30 received by the controller 26 indicate the nearby presence of the pedestrian 16 and/or the expression of the gesture 18 by the occupant 14 as described herein.

The controller 26 is generally configured or programmed to control movement of the host-vehicle 12 along the travel-path of the host-vehicle 12 by way of communication with the vehicle-controls 32 of the host-vehicle. The vehicle-controls 32 may include, but are not limited to, the means to control the steering, accelerator, and brakes of the host-vehicle 12. In one example instance, the controller 26 waits to move the host-vehicle 12 (e.g. applies the brakes) until after the pedestrian 16 crosses the travel-path 20 when the occupant 14 gestures to the pedestrian 16 to proceed across the travel-path 20. By way of further example, the host-vehicle 12 may wait for the person characterized as traveling on-foot 16A to proceed across a crosswalk 34 that passes in front of the host-vehicle 12, or wait for the person on a bicycle 16B and/or the person in the other-vehicle 16C to proceed through an intersection 36 that the travel-path 20 traverses.

To this end, the controller 26 may include a traffic-analysis-function 58 that considers data relevant to the locations of any pedestrians, other-vehicle, roadway markings, traffic signals, and the like to provide a path-planning-function 38 with options regarding the operation of the host-vehicle 12. The path-planning-function 38 may be configured to generally determine, among other things, the travel-path 20 for the host-vehicle, and instructs a vehicle-operation-function 40 to either wait, i.e. keep the host-vehicle 12 at the present position, or to proceed along the travel-path 20.

In some circumstances it may be difficult for the pedestrian 16 to see that the occupant 14 has made a particular gesture. For example, bright sun-light may cause glare on the windshield of the host-vehicle, or it may be night-time so the ambient light is inadequate, so the pedestrian 16 is unable see the gesture 18. In one embodiment the system 10, or more specifically the controller 26, is configured to operate a horn 42 of the host-vehicle 12, and activate the horn 42 when the occupant 14 gestures to the pedestrian 16 to proceed across the travel-path 20. In another embodiment the controller 26 may be configured to operate the headlights 44 of the host-vehicle, and flash the headlights 44 when the occupant 14 gestures to the pedestrian 16 to proceed across the travel-path 20. Alternatively, the controller may be configured to both activate the horn 42 and flash the headlights 44 when the occupant gestures to the pedestrian to proceed across the travel-path.

The decision to activate the horn 42 and/or flash the headlights 44 may be based on information from the pedestrian-detection-device 24 that indicates, for example, that the pedestrian 16 is looking away from the host-vehicle 12 so likely did not see the occupant 14 perform the gesture 18. The decision to activate the horn 42 and/or flash the headlights 44 may also be based on the relative-location of the pedestrian 16 relative to the host-vehicle. For example, the activation of the horn 42 may be especially useful to attract the attention of the person characterized as traveling on-foot 16A located as shown in FIG. 1. In contrast, the flashing of the headlights 44 may be especially useful to attract the attention of the person on a bicycle 16B and/or the person in the other-vehicle 16C located as shown in FIG. 1.

The decision for the host-vehicle 12 to either wait or proceed may also be based on further analysis of information from the pedestrian-detection-device 24 such as an other-vehicle intent 46, a pedestrian-gesture 48, or a pedestrian-intent 50. For example, if the person on a bicycle 16B appears to be resting and does not exhibit any intent to proceed soon, the host-vehicle 12 may proceed through the intersection 36 before the person on a bicycle 16B proceeds across the travel-path 20. As another example, the pedestrian-detection-device 24 may indicate that the person in the other-vehicle 16C expressed the pedestrian-gesture 48 to the occupant 14 to proceed, so the controller 26 operate the host-vehicle through the intersection 36 without waiting. Similarly, the pedestrian-intent 50 of the person characterized as traveling on-foot 16A may indicate that the person characterized as traveling on-foot 16A is talking to another person.

The controller 26 may also be configured to move the host-vehicle 12 along the travel-path 20 when the pedestrian 16 does not begin to proceed across the travel-path 20 during a wait-interval 52, e.g. three seconds (3s). That is, even if no particular type of the other-vehicle intent 46, the pedestrian-gesture 48, and/or the pedestrian-intent 50 is detected, the controller 26 may be configured to proceed if the pedestrian 16 makes no attempt to proceed for longer than the wait-interval 52.

Various schemes for vehicle-to-vehicle (V2V), vehicle-to-infrastructure (V2I), and vehicle-to-pedestrian (V2P) communications have been contemplated. To make use of any of these schemes, the system 10 may include a transceiver 54 usable for wireless communication with the pedestrian 16, for example to communicate with a smart-phone 56 carried/operated by the pedestrian 16. It follows that the controller 26 may be further configured to operate the transceiver 54 to communicate an intention of the host-vehicle 12 to either proceed or to wait for the pedestrian 16 to proceed across the travel-path 20.

FIG. 3 illustrates another non-limiting example of a traffic scenario that the system 10 may encounter when the pedestrian 16 is proceeding or is about to proceed across the travel-path 20, and an approaching-vehicle 60 is unable to see the pedestrian 20 because the line-of-sight from the approaching-vehicle 60 to the pedestrian 20 is occluded by the host-vehicle 12. The controller 26 may be configured to operate the transceiver 54 to communicate to the approaching-vehicle 60 that the pedestrian 16 is proceeding or is about to proceed across the travel-path 20 because the pedestrian 16 is responding to a gesture from the occupant 14, or the pedestrian 16 decided to proceed without receiving a gesture.

Alternatively, the host-vehicle 12 may transmit a signal to the approaching-vehicle 60 that the pedestrian 16 is likely to traverse the travel-path of the approaching vehicle independent of any gesture being expressed to the pedestrian 16. It is also contemplated that the pedestrian-detection-device 24, the transceiver 54, and the controller 26 could be part of infrastructure as part of a vehicle-to-infrastructure (V2I) system and not necessarily installed in the host-vehicle 12.

Accordingly, a gesture detection system (the system 10), a controller 26 for the system 10 and a method of operating the controller 26 and the system 10 are provided. The system 10 is equipped to detect a gesture 18 performed or expressed by the occupant 14 of the host-vehicle 12 to a pedestrian 16 nearby, and operate the host-vehicle 12 in accordance with the gesture 18. This provides for a more human-like and cooperative operational characteristic of the host-vehicle 12.

While this invention has been described in terms of the preferred embodiments thereof, it is not intended to be so limited, but rather only to the extent set forth in the claims that follow.

1. A gesture detection system suitable to operate an automated vehicle, said system comprising:
a gesture-detection-device used to detect a gesture made by an occupant of a host-vehicle;
a pedestrian-detection-device used to detect a pedestrian proximate to the host-vehicle; and
a controller in communication with the gesture-detection-device and the pedestrian-detection-device, said controller configured to determine when the gesture made by the occupant is directed to the pedestrian, and control movement of the host-vehicle along a travel-path of the host-vehicle, wherein the controller waits to move the host-vehicle until after the pedestrian crosses the travel-path when the occupant gestures to the pedestrian to proceed across the travel-path.

2. The system in accordance with claim 1, wherein the pedestrian is one of a person characterized as traveling on-foot, a person on a bicycle, a person in an other-vehicle.

3. The system in accordance with claim 1, wherein the controller is further configured to operate a horn of the host-vehicle, and activate the horn when the occupant gestures to the pedestrian to proceed across the travel-path.

4. The system in accordance with claim 1, wherein the controller is further configured to operate headlights of the host-vehicle, and flash the headlights when the occupant gestures to the pedestrian to proceed across the travel-path.

5. The system in accordance with claim 1, wherein the controller is further configured to operate a horn and the headlights of the host-vehicle, and activate the horn and flashes the headlights when the occupant gestures to the pedestrian to proceed across the travel-path.

6. The system in accordance with claim 1, wherein the controller is further configured to move the host-vehicle along the travel-path when the pedestrian does not begin to proceed across the travel-path during a wait-interval.

7. The system in accordance with claim 1, wherein the system includes a transceiver for wireless communication with the pedestrian, and the controller is further configured to operate the transceiver to communicate an intention to wait for the pedestrian to proceed across the travel-path.

8. The system in accordance with claim 1, wherein the system includes a transceiver for wireless communication with an approaching-vehicle, and the controller is further configured to operate the transceiver to communicate to the approaching-vehicle that the pedestrian is proceeding across the travel-path.

9-14. (canceled)
